(19) United States
(12) Patent Application Publication
(10) Pub. No.: US 2003/0137755 A1
(43) Pub. Date: Jul. 24, 2003

(54) Fixture for Reflection Mirror

(76) Inventors: Fan-Chieh Chang, Hsinchu City (TW); Kuo-Wen Chen, Hsinchu City (TW)

(21) Appl. No.: 10/248,398

(22) Filed: Jan. 16, 2003

(30) Foreign Application Priority Data
Jan. 18, 2002 (TW) 091200728

(51) Int. Cl. G02B 7/182

(52) U.S. Cl. 359/871; 248/467; 348/744

(57) ABSTRACT

### Abstract of Disclosure

The present invention is a fixture for reflection mirror. Wherein a plurality of adhering sections are set on surrounding edges inside a rear frame of a rear projection television. Depending on dimensions and weights of different reflection mirrors, an area of the adhering section can be adjusted. Then to coat glue on adhering sections, and the back surrounding edges of the reflection mirror is stuck on the adhering sections, therefore the reflection mirror is fixed on the rear frame. Due to the adhering sections being on the back of the reflection mirror, the reflection mirror is used as a reflection surface of reflecting a light beam back to a screen without blocking of the adhering sections and interference of the rear frame so as to effectively use the reflection surface.

### Background of Invention

1.Field of the Invention

This invention relates to a rear projection television, and more particularly, to a fixture for reflection mirror in the rear projection television.

2.Background of the Invention

In recent years, as the optical-electronic technology grows rapidly, the visualization of information becomes more and more important.The significance and demand for rear projection television as a display device increases drastically. Hence, how to simply and fast assemble the rear projection television for saving production time and cost and have the flexibility of productions of different dimensions for increasing the competition and popularity under the conditions of the production amount has become an important subject of the research and development in the industry.

Please refer to Figure 1 for the overall optical system structure of a prior-art rear projection television. A screen 10 in the front, a base 11 at the bottom, and a rear cover 12 at the backside constitute the interior of the rear projection television; wherein the interior of the rear projection television has a carrier 13 on the base 11, and the carrier 13 has an optical engine 14 on it. A first mirror 15 is fixed in the front of the optical engine 14, and furthermore a second mirror16 is disposed on the inner side of the rear cover 12 at the back of the screen 10. The operation of the optical system of the rear projection television is by means of generating a beam with video information from the optical engine 14 on the carrier 13 and projecting the beam onto the first mirror 15. The beam is then reflected onto thesecond mirror16 from the first mirror 15, and finally onto the screen 10, which constitutes the optical system projection architecture.

The prior art shows that the second mirror 16 is set on the rear cover 12. As shown in Figure 2, placing the second mirror 16 on a back of a frame 20, that is, four rims on the back of the frame 20 support the second mirror 16, and plural batten 21 are designed on the back of the frame 20. One side of every layering 21 presses on each edge of the second mirror 16; the other side of every layering 21 fastens the second mirror 16 on each edge of the back of the frame 20 via plural fasteners 211 (screws, rivets, etc.). By means of the batten 21 supporting and fixing the second mirror 16 on the back of the frame 20 and the back being on the rear cover 12, the light beam is capable of going through a front window 201 of the frame 20 to the second mirror 16 and the screen 10. On the other hand, another way in prior arts is that a front of the frame 20 is fixed on the rear cover 12, therefore, the light beam passes through the frame 20 and goes onto the second mirror 16 pressed by the batten 21, at last, the light beam being reflected to the screen 10. Due to batten 21 being fixed on the frame 20, thus batten 21 cannot be moved and suitable to variable dimensions of products; further, surrounding edges of a surface of the second mirror 16 being pressed by batten 21 or other surrounding edges of the other surface supporting on surrounding edges of the front window 201 of the frame 20 lets the surround edges of the second mirror 16 be shielded. As it can be seen, not only an effective reflection area of second mirror 16 is decreased, but also that material of the second mirror 16 is wasted. The layering 21 directly presses onto the second mirror 16 and a pressing force is stronger, and thus a situation of mirror 16 being broken by batten 21 may be happened; besides, due to the pressing force being not so strong and a gap being exist, the second mirror 16 may be shifted while a stronger collision happened, and then an unstable state is certainly generated to affect an optical precision.

Please refer to Figure 3, which is a fixing method of second mirror 16 in prior art, that is, the surrounding edges of the second mirror 16 are clamped by each end of an upper flexible piece 31 and a lower flexible piece 32, another ends of both flexible pieces 31 and 32 are connected each other by fasteners 33 for fixing the second mirror 16. The two ends of the flexible pieces 31 and 32 are then arranged on the rear cover 12 to let light beam project onto the second mirror 16 clamped by the flexible pieces 31 and 32, and continuously the light beam being reflected to the screen 10. Although the elastic forces of the flexible pieces 31 and 32 being capable of clamping second mirror 16 for avoiding the break of the second mirror 16, the elastic force may not be enough when in stronger collision, and thus an unstable state is still possibly happened; further that, the two flexible pieces cannot be applied on the products with different dimensions and shield the surrounding edges of the second mirror 16 to cause that the effective reflection area being decreased, and therefore the expensive optical material is truly wasted.

### Summary of Invention

The first objective of the present invention is to provide a fixture for reflection mirror, and a reflected way of a light beam from the mirror may not be blocked out; hence an effective reflection area is increased to avoid expensive optical components, and reduce the cost.

The second objective of the present invention is to provide a fixture for reflection mirror, and a fixation structured of the reflection mirror is simplified for fast assembling and increasing working efficiency.

The third objective of the present invention is to provide a fixture for reflection mirror, and a fixation position of the fixation device is variable to be suitable for products of different dimensions and convenience, therefore to reduce the cost.

The fourth objective of the present invention is to provide a fixture for reflection mirror, and a stability of the reflection mirror is promoted to maintain optical precision and avoid break of the mirror.

To approach above objectives, the present invention adopts that having plural adhering sections on surrounding edges inside a rear frame of a rear projection television. Depending on dimensions and weights of different reflection mirrors, an area of the adhering section can be adjusted. Then to coat glue on adhering sections, and the back surrounding edges of the reflection mirror is stuck on the adhering sections, therefore the reflection mirror is fixed on the rear frame. Due to the adhering sections being on the back of the reflection mirror, the reflection mirror is used as a reflection surface of reflecting a light beam back to a screen without blocking of the adhering sections and interference of the rear frame so as to effectively use the reflection surface.

### Brief Description of Drawings

FIG. 1 is a cross-sectional view of an overall optical system structure of a rear projection television according to the prior art.

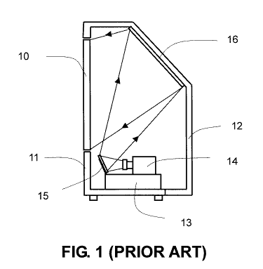

Figure 2 is a view of a fixation structure for a reflection mirror of the rear projection television according to the prior art.

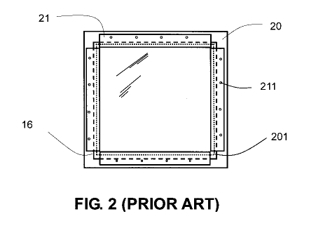

Figure 3 is a cross-sectional view of a fixation structure for a reflection mirror of another rear projection television according to the prior art.

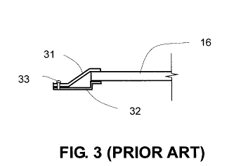

Figure 4 is a perspective view of a fixation structure for a reflection mirror according to a first preferred embodiment of the present invention.

Figure 5 is a view of a fixation structure for a reflection mirror of a fixation device according to the first preferred embodiment of Figure 4.

Figure 6 is a view of a fixation structure for a reflection mirror of a fixation device according to another preferred embodiment of the present invention.

### Detailed Description

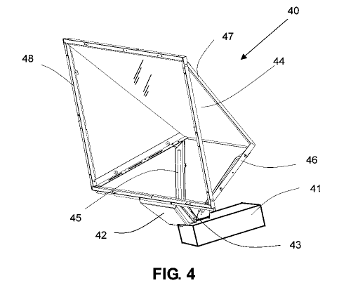

Please refer to Figure 4, which shows a fixation frame 40 of a rear projection television of a first preferred embodiment. The fixation frame 40 comprises a carrier 41 on the lower side; an optical engine (not shown in figure) is set aside of the carrier 41. An end edge of another side of the carrier 41 is extended as a supporter 42 of a first mirror. A first mirror 43 is fixed on the supporter 42. Two side-edges of the side of carrier 41 extend upward to become a lower frame 45. The lower frame 45 and the supporter 42 support an almost horizontal bottom frame 46 simultaneously. The bottom frame 46 is located on an end of the supporter 42 and set upwardly a rectangular front frame 48 to fix a screen (not shown in figure). The other end of the bottom frame 46 is installed upwardly and obliquely a rear frame 47. An upper end of the rear frame 47 and an upper end of a front frame 48 are connected each other. A second mirror 44 is installed on the interior of the rear frame 47 The above mention is then to construct the fixation frame 40 of an optical system of a fixed rear projection television.

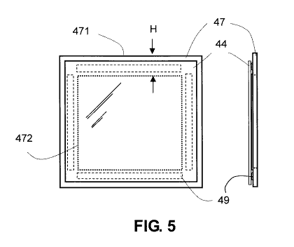

According to the advanced technologies of adhering and twin adhesive, a dependent adhering force and a durable adhering feature are provided in the market, such as the twin adhesive product from 3M. It is complied with the aforesaid advantages, which are also applied on the present invention. As showing in Figure 5, the rear frame 47 is inside of surrounding frames, and plural adhering sections 49 are designed on the rear frame 47. The area of each adhering section 49 is determined based on the dimensions and weight of the second mirror 44 and the specification of adhesive. Supplier usually provides the specification of adhering weight of adhesive, but it is not related to the present invention and will not be discussed hereinafter. Continuously, to coat glue or adhesive on adhering sections 49, and the back surrounding edges of the second mirror 44 is stuck on the adhering sections 49, therefore the second mirror 44 is fixed in the inside of rear frame 47. Due to the adhering sections 49 being on the back of the second mirror 44, the second mirror 44 is used as a reflection surface of reflecting a light beam back to a screen without blocking of the adhering sections 49 and interference of the rear frame 47 so as to effectively using the reflection surface. On the other hand, the present invention provides the way of easily putting the second mirror 44 in the rear frame 47, and further supplies a method of using a width between an inner rim 472 and an outer rim 471 of the rear frame 47 to fit with the second mirror 44 so as to adjust the location of the adhering sections 49 randomly. The method makes the rear frame 47 is suitable to variable sizes of second mirrors 44 for reducing cost.

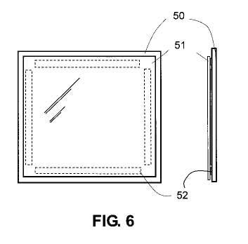

Please refer to Figure 6, which is a fixation device of a reflection mirror of another preferred embodiment of the present invention. The embodiment adopts an inner side of a rear cover 50 of a rear projection television to be directly as a supporter of a second mirror 51. The second mirror 51 is stuck on the inner side of the rear cover 50 that a light beam is straightly projected onto the second mirror 51. Hence, an effective area of the second mirror 51 is not partially blocked out. Plural adhering sections 52 are located around surrounding edges, and an area of each adhering section 52 is determined based on the dimensions and weight of the second mirror 51 and the specification of adhesive. Same theory as the fore preferred embodiment, the present embodiment is capable of adjusting the dimensions of the second mirror 51 and the location of adhering section 52 randomly according to the back area of the rear cover 50 for variable sizes of second mirror.

Similarly, the present invention of the technologies of using adhering or twin adhesive to fix a second mirror can completely be applied on fixing a first mirror, a screen or other components.

As aforesaid, the present invention is full of following functions:

1.To straightly stick adhering sections on the back of the reflection mirror. When supporting and fixing the reflection mirror, the reflection is not blocked out so as to increasing the reflection area and not wasting expensive optical components, thus reduce the cost.

2.To stick the reflection mirror by means of adhering and twin adhesive directly. It is to decrease the number of complicate batten and flexible pieces in prior art effectively for reducing material cost, and further to simplify the fixation structure of the reflection mirror and speed up the assembling for promoting production rate without the steps of screwing and other assembling processes.

3.To use the features with changeable sizes of the frame width and the rear cover area and the changeable location of adhesive, thus different sizes of reflection mirrors are suitable. It is that the present invention is with flexibility and convenience to reduce production cost and promoting competition.

4.To adopt the way of adhering is to relatively fix the reflection mirror and the frame/rear cover so as to increasing the stability of installing the reflection mirror and assuring the optical precision for not breaking the reflection mirror.

Moreover, the preferable embodiment described in above section is to illustrate the invention in a detailed way and is not limitation to the scope of the invention. Those who are skilled in such arts should understand that their appropriate and slight variation and modification still keep the merits of the invention and are also within the spirit and scope of the invention.

Claims

1. What is claimed is:
1.Fixture for reflection mirror comprising:
a rear cover of a rear projection television having an inner surface;
at least one adhering section located around surrounding edges of the inner surface and having some adhesive; and
a mirror having a front reflection surface and a rear reflection surface corresponding to the front reflection surface, the rear reflection surface adhered on the adhering section by means of the adhesive.

2.The fixture for reflection mirror of claim 1, wherein the adhesive is a twin adhesive.

3.The fixture for reflection mirror of claim 1, wherein the mirror is a firstmirror.

4.The fixture for reflection mirror of claim 1, wherein the mirror is a second mirror.

5.The fixture for reflection mirror of claim 1, wherein a frame is between the rear cover and the mirror, the frame has a surface toinstall the adhering section.
